(19) United States
(12) Patent Application Publication
(10) Pub. No.: US 2026/0261138 A1
(43) Pub. Date: Sep. 3, 2026

(54) CHARGING SYSTEM

(71) Applicant: Astemo, Ltd., Chiyoda-ku, Tokyo (JP)

(72) Inventors: Yuki OKUDA, Hitachinaka-shi, Ibaraki (JP); Takashi OKADA, Hitachinaka-shi, Ibaraki (JP); Hiroyuki OOIWA, Hitachinaka-shi, Ibaraki (JP); Shogo MIYAMOTO, Hitachinaka-shi, Ibaraki (JP); Yasuaki SATO, Hitachinaka-shi, Ibaraki (JP)

(73) Assignee: Astemo, Ltd., Chiyoda-ku, Tokyo (JP)

(21) Appl. No.: 19/164,994

(22) PCT Filed: Mar. 15, 2023
(86) PCT No.: PCT/JP2023/010062

§ 371 Date: Sep. 12, 2025

(51) Int. Cl. H02J 7/80; B60L 1/00; B60L 53/62; H01M 10/46; H01M 10/48; H01M 50/249

(52) U.S. Cl. CPC H02J 7/80; B60L 1/00; B60L 53/62; H01M 10/46; H01M 10/48; H01M 50/249; H01M 2220/20

(57) ABSTRACT

Provided is a charging system that easily secures a discharge amount of a battery necessary for measurement of an open circuit voltage of the battery.

The charging system that charges a battery 11 mounted on a vehicle 1 with power supplied from an external power supply includes: a charging/discharging control unit 32 that controls execution of charging and discharging of the battery 11; a voltage acquisition unit 33 that acquires a result of measuring a voltage of the battery 11 at a predetermined timing from a voltage measurement unit 14 that measures the voltage of the battery 11; a charge/discharge amount determination unit 29 that determines a charge/discharge amount of the battery 11 necessary for measurement of an open circuit voltage OCV of the battery 11; and a discharge allocation determination unit 31 that determines a discharge allocation which is an allocation of an internal discharge amount consumed by internal equipment 18 of the vehicle 1 and an external discharge amount consumed by external equipment 111 of the vehicle 1, the internal discharge amount and the external discharge amount being necessary for discharging of the charge/discharge amount in the battery 11, in which the discharge allocation determination unit 31 allows an allocation in which the internal discharge amount and the external discharge amount are simultaneously larger than 0.

### TECHNICAL FIELD

The present invention relates to a charging system.

### BACKGROUND ART

In the case of using vehicle-to-everything (V2X) to connect an electric vehicle (EV) to a home or a power grid, an opportunity to charge or discharge a battery mounted on the EV increases, and thus it is important to grasp (diagnose) a state of the battery such as battery deterioration. In the diagnosis of grasping the state of the battery, an open circuit voltage of the battery is measured to estimate a state of charge.

For example, paragraph 0007 of PTL 1 describes that “As a result repeating an experiment to reduce the influence of hysteresis occurring in a correspondence relationship between the open circuit voltage and the state of charge, the present inventor has found that the influence of the hysteresis can be reduced by performing both discharging and charging of a lithium ion secondary battery. Based on this, discharging and charging are performed before estimating the state of charge of the lithium ion secondary battery, and the state of charge of the lithium ion secondary battery is estimated from the open circuit voltage acquired thereafter. As a result, the state of charge can be estimated from the open circuit voltage in which the influence of the hysteresis is reduced, and estimation accuracy for the state of charge of the lithium ion secondary battery can be improved. The full-charge capacity estimation unit estimates the full-charge capacity by using the more accurately estimated state of charge. Therefore, estimation accuracy for the full-charge capacity can also be improved”.

Here, FIG. 1 and paragraphs 0025 to 0027 of PTL 1 describe that power is supplied to the load L in a building as a discharge destination.

In addition, paragraph 0038 of PTL 1 describes that “Here, since the charging/discharging control unit 35 causes the battery 12 to discharge according to the power demand of the load L, the discharge power of the battery 12 depends on the power demand, and the discharge power cannot be controlled. Therefore, the charging/discharging control unit 35 grasps the amount of discharging current of the battery 12 discharged according to the power demand, and controls the bidirectional inverter 32 such that the amount of discharging current and the amount of charging current are the same as each other, thereby performing discharging and charging of the battery 12”.

Further, paragraph 0067 of PTL 1 describes that “the embodiment and the following modified examples can be implemented in combination within a range not technically contradictory”.

Further, paragraphs 0067 and 0068 of PTL 1 describe that the power is supplied to the in-vehicle load 80 as a discharge destination as a modified example, and paragraph 0068 of PTL 1 describes that “The load 80 is an in-vehicle load driven by the power of the battery 12, and is, for example, a traveling motor, a motor for driving an electric compressor used for air conditioning, or the like”.

### CITATION LIST

### Patent Literature

PTL 1: JP 2020-41977 A

### SUMMARY OF INVENTION

### Technical Problem

In the modified example of PTL 1, instead of supplying the power to the load L in a building as a discharge destination, for example, it is assumed that the traveling motor or the motor for driving the electric compressor used for air conditioning is used as a discharge destination. However, in this case, there is a problem that a sufficient discharge amount may not be secured.

Here, in PTL 1, although there is a description that “the embodiment and the following modified examples can be implemented in combination within a range not technically contradictory”, a specific manner of such combination is not clarified.

PTL 1 describes “causing the battery 12 to discharge according to the power demand of the load L”, and thus, for example, as an example of the combination, a configuration is conceivable in which one discharge destination is selected and switched such that discharging for the outside is performed when the power demand of the external load L is high, and discharging for the internal in-vehicle load 80 is performed when the power demand is low. However, even in this case, since the discharging can be performed only for either the outside or the inside, there is a problem that a sufficient discharge amount cannot be secured.

An object of the present invention is to provide a charging system that easily secures a discharge amount of a battery necessary for measurement of an open circuit voltage of the battery.

### Solution to Problem

In order to solve the above problems, a charging system of the present invention is a charging system that charges a battery mounted on a vehicle with power supplied from an external power supply, the charging system including: a charging/discharging control unit that controls execution of charging and discharging of the battery; a voltage acquisition unit that acquires a result of measuring a voltage of the battery at a predetermined timing from a voltage measurement unit that measures the voltage of the battery; a charge/discharge amount determination unit that determines a charge/discharge amount of the battery necessary for measurement of an open circuit voltage of the battery; and a discharge allocation determination unit that determines a discharge allocation which is an allocation of an internal discharge amount consumed by internal equipment of the vehicle and an external discharge amount consumed by external equipment of the vehicle, the internal discharge amount and the external discharge amount being necessary for discharging of the charge/discharge amount in the battery, in which the discharge allocation determination unit allows an allocation in which the internal discharge amount and the external discharge amount are simultaneously larger than 0.

### Advantageous Effects of Invention

According to the present invention, since the discharge allocation determination unit is provided and an allocation in which the internal discharge amount and the external discharge amount are simultaneously larger than 0 is allowed, it is possible to provide a charging system that easily secures a discharge amount of a battery necessary for measurement of an open circuit voltage of the battery.

Other configurations and effects of the present invention will be described in embodiment.

### BRIEF DESCRIPTION OF DRAWINGS

FIG. 1 is a circuit diagram illustrating an equivalent circuit model of a lithium ion secondary battery cell.

FIG. 2 is a waveform diagram for describing voltage behavior of the battery cell after charging is stopped.

FIG. 3 is a functional block diagram of an overall configuration including a charging system of a first embodiment.

FIG. 4 is a waveform diagram for describing an example in which a vehicle is used for vehicle-to-home (V2H).

FIG. 5 is a waveform diagram for describing a process of discharging a battery in order to eliminate polarization.

FIG. 6 is a diagram for describing a process in which a discharge allocation determination unit selects a discharge destination.

FIG. 7 is a flowchart for describing an operation of a second embodiment.

FIG. 8 is a time-series waveform diagram of a power demand of a home for describing an operation of a third embodiment.

FIG. 9 is a timing chart for describing an operation of a fourth embodiment.

FIG. 10 is a waveform diagram for describing an operation of a fifth embodiment.

FIG. 11 is a flowchart for describing an operation of a sixth embodiment.

FIG. 12 is a waveform diagram for describing a process of measuring an apparent open circuit voltage (OCV) for describing an operation of a seventh embodiment.

### DESCRIPTION OF EMBODIMENTS

Hereinafter, embodiments of the present invention will be described with reference to the drawings. In the figures and the embodiments, the same or similar components are denoted by the same reference numerals, and redundant description is omitted.

### First Embodiment

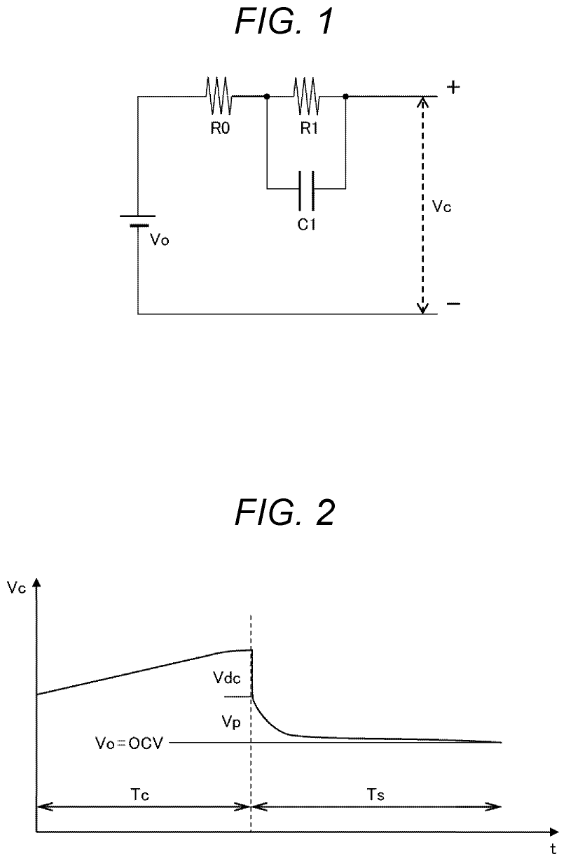

FIG. 1 is a circuit diagram illustrating an equivalent circuit model of a lithium ion secondary battery cell.

A voltage source Vo is an electromotive force caused by direct conversion of chemical energy into electric energy by intercalation and deintercalation reactions of lithium ions at a positive electrode and a negative electrode included in a lithium ion secondary battery used in a battery, and a voltage of the voltage source Vo corresponds to an open circuit voltage (OCV) of the battery. Hereinafter, the open circuit voltage OCV may be simply abbreviated as OCV.

Hereinafter, the lithium ion secondary battery is referred to as a battery cell, and unless otherwise specified, the battery cell refers to the lithium ion secondary battery. A battery module refers to a combination of a plurality of such battery cells connected in series or in parallel to obtain desired characteristics in order to be used as, for example, a power supply for driving an electric vehicle.

A resistance component R0 represents a resistance component when a current flows to an electrolyte solution or an electrode included in the battery cell. An electrode reaction accompanying charging and discharging of the battery cell is accompanied by charging of an electric double layer present at an interface between an electrode active material and the electrolyte solution, a charge transfer reaction in the electrode active material or in the electrode, and a diffusion reaction in the electrode active material, and a capacitance component C1 corresponding to the charging of the electric double layer and a resistance component R1 and the like based on various reactions are included in the equivalent circuit model.

In an actual operation mode of the battery cell, a terminal voltage Vc can be measured by a voltage sensor or the like. A correspondence relationship between the OCV and a state of charge of the battery cell is known, and the state of charge of the battery cell can be known from an OCV measurement result by obtaining the correspondence relationship in advance and holding the correspondence relationship as a table function by a control device such as an integrated controller. In the case of using the battery using the battery module as the power supply of an electric vehicle, it is possible to estimate a cruising distance or the like by grasping the state of charge.

In addition, it is also possible to use deterioration estimation or the like using the fact that the relationship between the OCV and the state of charge changes according to the deterioration of the battery cell. That is, it can be said that measuring the OCV or estimating the OCV by some methods is an essential process when operating the battery cell.

FIG. 2 is a waveform diagram for describing voltage behavior of the battery cell after charging is stopped. In FIG. 2, the vertical axis represents the terminal voltage Vc, and the horizontal axis represents a time t.

When the battery cell is charged at a constant current value, the terminal voltage Vc illustrated in FIG. 1 increases with the progress of charging in a charge period Tc.

This is because, by a charging operation, a positive electrode potential moves in a noble direction by a reaction in which a lithium transition metal composite oxide, which is the amount of a positive electrode material included in the battery cell, is oxidized and the lithium ions are extracted into the electrolyte solution in the battery cell, and a negative electrode potential approaches a lithium metal potential, that is, moves in a base direction by the lithium ions being taken in between crystal layers of a carbon material, which is a negative electrode material, and thus a potential difference therebetween increases, whereby the voltage source Vo (=OCV) increases, and in addition, a direct current (DC) voltage is generated in the resistance components R0 and R1 by a flow of the current.

In the charge period Tc, the terminal voltage Vc is obtained by combining the voltage source Vo, a DC voltage Vdc generated in the resistance components R0 and R1, and a polarization voltage Vp generated by charges accumulated in the capacitance component C1 accompanying the charging reaction. Therefore, during and immediately after charging, the voltage source Vo<the terminal voltage Vc.

In a rest period Ts, when charging is stopped, the DC voltage Vdc generated in the resistance components R0 and R1 disappears due to a charging current, so that the terminal voltage Vc immediately decreases. However, since the polarization voltage Vp is generated by the charges accumulated in the capacitance component C1, the terminal voltage Vc gradually decreases until the charges of the capacitance component C1 are consumed, and the terminal voltage Vc converges to the voltage source Vo (=OCV) in due course.

In the case of discharging, reversely, the voltage source Vo>the terminal voltage Vc immediately after discharging. In addition, when discharging is stopped, a voltage drop caused by the DC voltage Vdc is eliminated and the voltage immediately rises, and then a voltage drop caused by the polarization voltage Vp is eliminated and the terminal voltage Vc converges to the voltage source Vo (=OCV) while gradually rising toward the voltage source Vo.

In order to eliminate such a polarization voltage Vp, a time of several minutes to several hours is required, and in particular, in a case where a negative electrode active material contains silicon in order to increase a capacity of the battery cell, a particularly long time is required. From this, it can be seen that OCV measurement cannot be performed immediately even when charging and discharging is stopped.

Therefore, by discharging the battery cell immediately after being charged for a short time and charging the battery cell immediately after being discharged for a short time, the charges that generate the polarization voltage Vp are consumed, and the OCV measurement can be performed at an early stage.

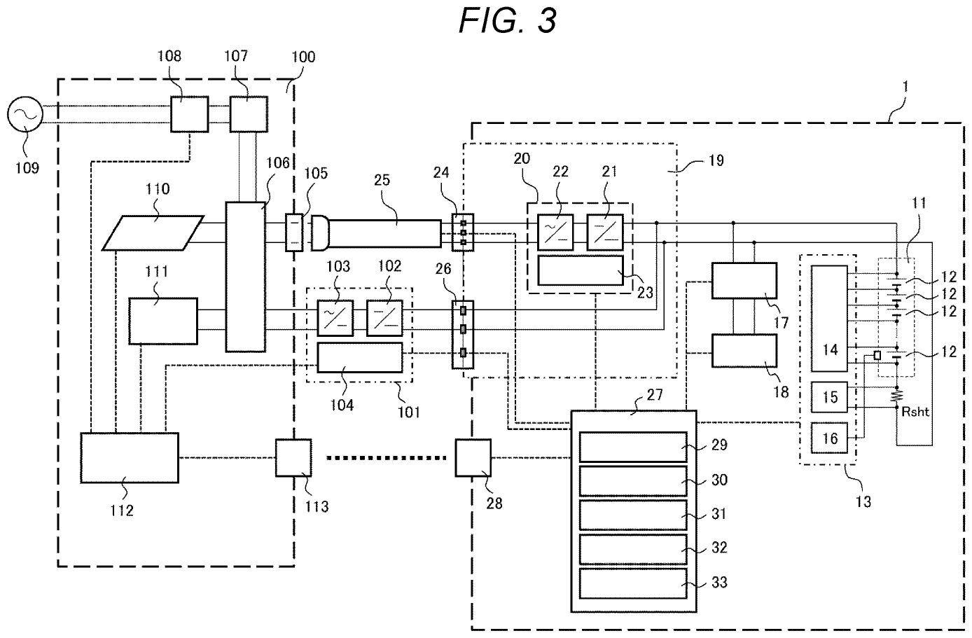

FIG. 3 is a functional block diagram of an overall configuration including a charging system of a first embodiment.

In FIG. 3, an example in which a vehicle 1 which is an electric vehicle and a home 100 assumed to be a detached house are connected is described, but the home 100 is not necessarily limited to a detached house in which an owner of the vehicle 1 lives. For example, the home 100 may be an apartment house, or a facility corresponding to the home 100 may be an office or a parking lot. A plurality of vehicles 1 may be connected.

The charging system of the first embodiment is a system that charges a battery 11 mounted on the vehicle 1 with power supplied from an external power supply, and includes an integrated controller 27, the battery 11, a voltage measurement unit 14, a bidirectional charger 20, internal equipment 18, and a power conversion device 17.

The battery 11 is mounted on the vehicle 1, and includes a battery module capable of implementing a desired output characteristic by connecting a plurality of battery cells 12 in series or in parallel.

A monitoring unit 13 capable of detecting a state of the battery 11 is connected to the battery 11. The monitoring unit 13 includes a voltage measurement unit 14 capable of detecting a voltage of the battery 11, more specifically, a voltage of the battery cell 12 of the battery 11, a current measurement unit 15 capable of detecting a current flowing through the battery cell 12, and a temperature measurement unit 16 that detects a temperature of the battery 11. The voltage measurement unit 14 is configured such that a voltage line is attached between the battery cells 12 so that terminal voltages of the battery cells 12 can be individually measured. In FIG. 3, the current measurement unit 15 refers to, for example, a sensor of a type that detects a current by measuring a voltage of a shunt resistor Rsht, but the current measurement unit 15 is not limited thereto, and a sensor such as a Hall element can be used. A thermistor, a thermocouple, or the like can be used as the temperature measurement unit 16. As described above, the monitoring unit 13 detects the state of the battery 11 by converting the state into voltage information. Therefore, a semiconductor device such as a general-purpose analog front-end integrated circuit (IC) or an application specific integrated circuit (ASIC) can be used. As an A/D converter is provided, a state quantity of the battery 11 detected as a voltage can be converted into a digital value that can be used in arithmetic processing of a program or the like.

The battery 11 is connected to the power conversion device 17, and electric energy is used by the internal equipment 18 in a desired manner.

The power conversion device 17 performs power conversion on power discharged from the battery 11 and supplies the power to the internal equipment 18.

The power conversion device 17 is, for example, a bidirectional inverter, and thereby drives a traveling motor used for traveling of the vehicle 1. The bidirectional inverter includes a DC/DC converter unit and an inverter unit, the DC/DC converter unit converts a DC voltage of the battery 11 into a voltage necessary for driving the traveling motor, and the inverter unit converts DC power into AC power to perform frequency control according to a rotation speed of the traveling motor and power the traveling motor, thereby obtaining a rotational force (drive torque) for accelerating the vehicle. Alternatively, at the time of decelerating the vehicle, regenerative driving is performed, kinetic energy of the vehicle is regenerated as power, and the power is sent back to the battery 11 via the DC/DC converter unit to charge the battery cell 12.

The internal equipment 18 is, for example, the above-described traveling motor, and accelerates the vehicle 1 by using the power as the rotational force, and an inertial force of the vehicle 1 is regenerated as the power by driving the traveling motor as a generator in cooperation with the bidirectional inverter during traveling of the vehicle 1.

In order to implement such an operation, the power conversion device 17 includes a controller (not illustrated), adjusts an output voltage of the DC/DC converter unit by controlling a duty ratio of a switching element of the DC/DC converter unit, and adjusts a driving force of the traveling motor by adjusting a switching frequency and a current phase of the inverter unit. The internal equipment 18 is provided with various sensors for the power conversion device 17 to control the internal equipment 18 in a desired manner.

The power conversion device 17 is also an inverter different from, for example, the bidirectional inverter for driving the traveling motor described above, and the internal equipment 18 is also a compressor driving motor. Therefore, an air conditioner for air-conditioning a vehicle compartment of the vehicle 1 is driven.

That is, the power conversion device 17 and the internal equipment 18 are means for consuming the power of the battery 11, in other words, one of means for discharging the power of the battery 11, and a plurality of power conversion devices 17 and internal equipment 18 are provided in the vehicle 1.

The battery 11 is connected to a charging circuit 19.

The charging circuit 19 supports AC charging via the bidirectional charger 20 and DC charging via a stationary charger 101. The AC charging and the DC charging are exclusively used by a relay or a semiconductor switch (not illustrated) in the charging circuit 19. The bidirectional charger 20 is mounted on the vehicle 1, and bidirectionally converts the power supplied from the external power supply such as the home 100 and the power discharged from the battery 11. The stationary charger 101 is installed outside the vehicle 1 and the home 100, and bidirectionally converts the power supplied from the power supply such as the home 100 and the power discharged from the battery 11.

In the AC charging, the bidirectional charger 20 is further connected to a charging cable 25 via an AC charging port 24, and the charging cable 25 is connected to an AC outlet 105 of the home 100. The AC outlet 105 of the home 100 is connected to a distribution board 106, and the distribution board 106 is further electrically connected to a power grid 109 via a circuit breaker 107 and a power meter 108.

In the DC charging, connection to the stationary charger 101 is made via a DC charging port 26 through a path different from the bidirectional charger 20 in the charging circuit 19, and the stationary charger 101 is connected to the distribution board 106 in the home 100. Thereafter, similarly to the AC charging, the power grid 109 is electrically connected.

The bidirectional charger 20 includes a DC/DC converter unit 21 capable of transforming at least a DC voltage, an inverter unit 22 capable of rectifying AC power from the AC outlet 105 into DC power and converting DC power output from the DC/DC converter unit 21 into AC power, and a control unit 23 that controls the DC/DC converter unit 21 and the inverter unit 22.

Similarly to the bidirectional charger 20, the stationary charger 101 also includes a DC/DC converter unit 102, an inverter unit 103, and a control unit 104.

When charging the battery 11, so-called constant current constant voltage charging in which constant current charging and constant voltage charging corresponding to the battery cell 12 in the battery 11 are combined is performed.

Specifically, in a state in which a state of charge of the battery 11 is low, the constant current charging is performed, and a charging speed is adjusted such that a current flowing through the battery cell 12 in the battery 11 does not become a predetermined value or more. When an excessive current flows through the battery cell 12, lithium ions are not taken in between negative electrode active material layers in the battery cell 12, and lithium metal is deposited on the negative electrode, causing an internal short circuit, which may lead to thermal runaway accompanied by ignition or rupture of the battery cell 12. In order to prevent this, it is necessary to control the charging speed, that is, the current, such that an excessive current does not flow.

When the charging of the battery 11 progresses and the voltage of the battery cell rises, transitioning to the constant voltage charging is made. When the voltage of the battery cell 12 excessively increases, lithium ions are extracted from a positive electrode active material, an electrode structure becomes brittle, and reactivity of the positive electrode increases, as a result of which gas is generated in the battery cell 12 due to a decomposition reaction of an electrolytic solution, and heat is also generated due to the decomposition reaction of the electrolytic solution. Since the gas generated in the battery cell 12 and the electrolytic solution are flammable, there is a possibility that ignition of the gas and the electrolytic solution causes destruction such as ignition of the battery cell 12 and rupture due to an increase in gas pressure. Similarly to the current, it is necessary to control the voltage so as not to become excessive.

Taking the bidirectional charger 20 as an example, the inverter unit 22 rectifies AC power obtained through the AC charging port 24 into DC power and controls the duty ratio of the switching element of the DC/DC converter unit 21 to control the charging current and the charging voltage flowing to the battery cell 12 and eventually to the battery 11. Similarly, in the stationary charger 101, the inverter unit 103 rectifies AC power obtained through the distribution board 106 into DC power and controls the duty ratio of the switching element of the DC/DC converter unit 102 to control the charging current and the charging voltage flowing to the battery cell 12 and eventually to the battery 11.

As described above, the charging of the battery 11 can be performed by the bidirectional charger 20 or the stationary charger 101.

When the power of the battery 11 is supplied to the home 100, the DC/DC converter unit 21 of the bidirectional charger 20 adjusts the voltage according to AC power used in the home 100. The inverter unit 22 generates an alternating current such that a frequency and a phase of the AC power used in the home 100 are synchronized. The control unit 23 adjusts a duty ratio of a switching signal to be commanded to the switching element of the DC/DC converter unit 21 for voltage adjustment, and feeds back the frequency and the phase of the AC power in the home 100 and adjusts a switching command of the inverter unit 22 so as to be synchronized with the frequency and the phase in order to send power to the home 100.

The same applies to a case where the power of the battery 11 is supplied to the home 100 through the stationary charger 101, and the DC/DC converter unit 102, the inverter unit 103, and the control unit 104 are operated like the DC/DC converter unit 21, the inverter unit 22, and the control unit 23 of the bidirectional charger 20.

By allowing the power of the battery 11 to be used in the home 100 through the bidirectional charger 20 or the stationary charger 101, for example, the power of the battery 11 can be used in a case where there is no power supply from the power grid 109 at the time of disaster, or an amount of power purchased from the power grid 109 can be reduced to reduce electricity costs for the home 100.

The home 100 may further include a solar power generation system 110 or a fuel cell system (not illustrated) as a power supply as a substitute for the power grid 109.

In addition to the solar power generation system 110 described above, external equipment 111 is connected to the distribution board 106 of the home 100. The external equipment 111 is a house facility of the home 100 or a so-called electric appliance, and examples thereof include an air conditioner for air-conditioning the home 100, a hot water supply system, an illumination, a cooking appliance, a refrigerator, a white appliance such as a washing machine, a black appliance such as a television or a stereo system, and an information appliance such as a personal computer or a telephone.

Supplying the power of the battery 11 to the home 100 via the bidirectional charger 20 or the stationary charger 101 means consuming the power of the battery 11, in other words, is one of the other means for discharging the power of the battery 11.

The home 100 includes a home energy management system (HEMS) 112, and can adjust an operation state and a power generation amount of the solar power generation system 110 and the hot water supply system serving as the external equipment 111, a water boiling timing of the hot water supply system serving as the external equipment 111 according to a power demand of the home 100 acquired from the power meter 108, and an operation state of the air conditioner serving as the external equipment 111, and perform selling of surplus power of the solar power generation system 110 to the power grid 109, and the like. In addition, the HEMS 112 is configured to be able to query the power demand of the home 100 from the outside via a communication module 113, and the integrated controller 27 of the vehicle 1 is configured to be able to acquire information such as the power demand of the home 100 and upper limit power of the circuit breaker 107 held by the HEMS 112 from the communication module 113 through a telematics unit 28 of the vehicle 1. The upper limit power of the circuit breaker 107 is also power that can be supplied by the home 100 as the external power supply.

The integrated controller 27 includes, as functional blocks, a charge/discharge amount determination unit 29, a power information acquisition unit 30, a discharge allocation determination charging/discharging control unit 32, and a voltage acquisition unit 33. Details of an operation of each functional block of the integrated controller 27 are described below.

The integrated controller 27 includes a computation unit implemented by a central processing unit (CPU) or the like, and a storage unit implemented by a memory such as a random access memory (RAM) or a read only memory (ROM), a recording medium, or the like, and implements each functional block of the integrated controller 27 by executing a program stored in the storage unit.

As indicated by a broken line in FIG. 3, the integrated controller 27 is configured to be able to acquire operation states of the power conversion device 17 and the internal equipment 18 and the state of the battery 11 as necessary, and to be able to communicate with the bidirectional charger 20 included in the charging circuit 19 and communicate with the stationary charger 101 through the DC charging port 26. The integrated controller 27 can also perform communication via the AC charging port 24 and the charging cable 25. A communication scheme such as a controller area network (CAN) or a local interconnect network (LIN), Ethernet connection, or the like can be used for the communication indicated by the broken line in FIG. 3, and there is no problem even if the CAN or LIN is used in the vehicle 1 and communication using Ethernet is used for communication in the home 100. In addition, communication using power line communication (PLC) or the like may be used. Not only wired communication but also wireless communication may be performed.

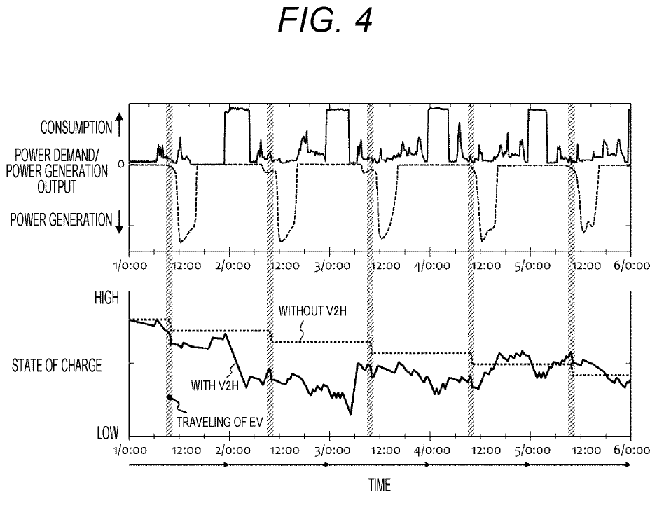

FIG. 4 is a waveform diagram for describing an example in which the vehicle is used for V2H.

The graph in the upper part of FIG. 4 illustrates the power demand (solid line) of the home 100 and a power generation output (broken line) of the solar power generation system 110 included in the home 100, where an upward direction along the vertical axis represents consumption, a downward direction along the vertical axis represents power generation, and the horizontal axis represents time. The graph in the lower side of FIG. 4 illustrates a simulation result for a change in the state of charge of the battery 11 of the vehicle 1, where the vertical axis represents the state of charge and the horizontal axis represents time.

In FIG. 4, an operation (V2H use) for the purpose of reducing the amount of power purchased from the power grid 109 by supplying the power of the battery 11 to the home 100 to reduce the electricity costs for the home 100 is assumed, and a solid line in the lower part of FIG. 4 indicates a result with V2H and a broken line indicates a result without V2H. The time on the horizontal axis indicates a period of five days from 0:00 on the first day to 24:00 on the fifth day (0:00 on the sixth day).

As illustrated in the upper part of FIG. 4, the home 100 is an electrified house, and a high power demand accompanying a boiling operation of the hot water supply system serving as the external equipment 111 is generated during a midnight period, the power generated by the solar power generation system 110 is consumed in the home 100 during the daytime, and a charge amount of the battery 11 is adjusted such that the electricity costs for the home 100 become the lowest while using the surplus power for charging the battery 11, selling the power to the power grid 109, or using the surplus power for charging the battery 11 and selling the power to the power grid 109.

In the lower part of FIG. 4, a shaded period is an EV traveling period, in which connection between the vehicle 1 and the home 100 is disconnected as the vehicle 1 is used for movement of a resident. Therefore, a change in the state of charge during the period is caused by traveling of the vehicle 1. As compared with a case of using the power of the in-vehicle battery 11 only for traveling (without V2H), in the case of using V2H (with V2H), charging and discharging of the battery 11 are repeated, and it can be seen that there is a limit in a time during which the battery 11 can rest in order to eliminate the polarization voltage generated in the battery cell 12 in the battery 11 at the time of OCV measurement. If the OCV of the battery cell 12 can be obtained at an early stage, it is possible to shorten a time for which charging and discharging of the battery 11 are stopped for detection of the state of charge or deterioration determination by OCV measurement or estimation, and it is possible to increase an opportunity to obtain the electricity cost reduction effect as described above.

When charging the battery 11, the home 100 is used as a power supply, and the battery 11 is charged by power supply from the power grid 109 or the solar power generation system 110. On the other hand, when discharging the battery 11, the power of the battery 11 can be discharged by using the external equipment 111 of the home 100, and the power of the battery 11 can also be discharged by using the power conversion device 17 and the internal equipment 18 of the vehicle 1.

As illustrated in FIG. 4, since the power demand of the home 100 dynamically fluctuates, there is a possibility that a sufficient discharge amount for eliminating the polarization voltage generated in the battery cell 12 of the battery 11 cannot be secured simply by discharging the battery 11 so as to satisfy the power demand of the home 100.

Therefore, in order to cope with such a problem, the integrated controller 27 of the charging system of the first embodiment includes the charge/discharge amount determination unit 29, the power information acquisition unit 30, the discharge allocation determination unit 31, the charging/discharging control 32, and the voltage acquisition unit 33.

The charging/discharging control unit 32 controls execution of charging and discharging of the battery 11. Specifically, the charging/discharging control unit 32 issues a predetermined operation command to the controller (not illustrated) of the power conversion device 17, the control unit 23 of the bidirectional charger 20, or the control unit 104 of the stationary charger 101, thereby performing control to cause the control units to perform a predetermined operation, and controlling execution of charging and discharging of the battery 11.

The voltage acquisition unit 33 acquires a result of measuring the voltage of the battery 11 at a predetermined timing from the voltage measurement unit 14 that measures the voltage of the battery 11.

The charge/discharge amount determination unit 29 determines a charge/discharge amount of the battery 11 necessary for measurement of the open circuit voltage OCV of the battery 11.

The discharge allocation determination unit 31 determines a discharge allocation which is an allocation of an internal discharge amount consumed by the internal equipment 18 of the vehicle 1 and an external discharge amount consumed by the external equipment 111 of the vehicle 1, the internal discharge amount and the external discharge amount being necessary for discharging of the charge/discharge amount described above in the battery 11. Here, the discharge allocation determination unit 31 allows an allocation in which the internal discharge amount and the external discharge amount are simultaneously larger than 0. That is, by allowing both the external equipment 111 and the internal equipment 18 to simultaneously consume the power discharged from the battery 11 instead of consuming the power discharged from the battery 11 only by the external equipment 111 or only by the internal equipment 18, it is possible to easily secure the discharge amount of the battery 11 necessary for measurement of the open circuit voltage OCV of the battery 11.

More specifically, in the present embodiment, the charge/discharge amount determination unit 29 determines the charge/discharge amount necessary for eliminating the polarization of the battery 11, and the voltage acquisition unit 33 acquires a result of measuring the voltage of the battery 11 at a timing after both charging and discharging of the charge/discharge amount described above are performed in the battery 11. At this time, the charge/discharge amount described above includes information regarding a magnitude of a current and a timing, and the charge/discharge amount determination unit 29 desirably determines the charge/discharge amount such that the magnitude of the current in one of charging and discharging that is performed later is equal to or larger than the magnitude of the current in the other of charging and discharging that is performed earlier. As a result, the polarization of the battery 11 can be eliminated at an early stage and the OCV measurement can be performed.

In the present embodiment, the power information acquisition unit 30 acquires power consumable by the external equipment 111 and power consumable by the internal equipment 18. Then, the discharge allocation determination unit 31 determines the discharge allocation based on the charge/discharge amount and the information from the power information acquisition unit 30. As a result, it is possible to determine an appropriate discharge allocation in consideration of power consumable by the external equipment and power consumable by the internal equipment 18.

Hereinafter, operations of the charge/discharge amount determination unit 29, the power information acquisition unit 30, the discharge allocation determination unit 31, the charging/discharging control unit 32, and the voltage acquisition unit 33 in the integrated controller 27 will be described separately for a case of discharging the battery 11 in order to eliminate the polarization of the battery cell 12 in the battery 11 and a case of charging.

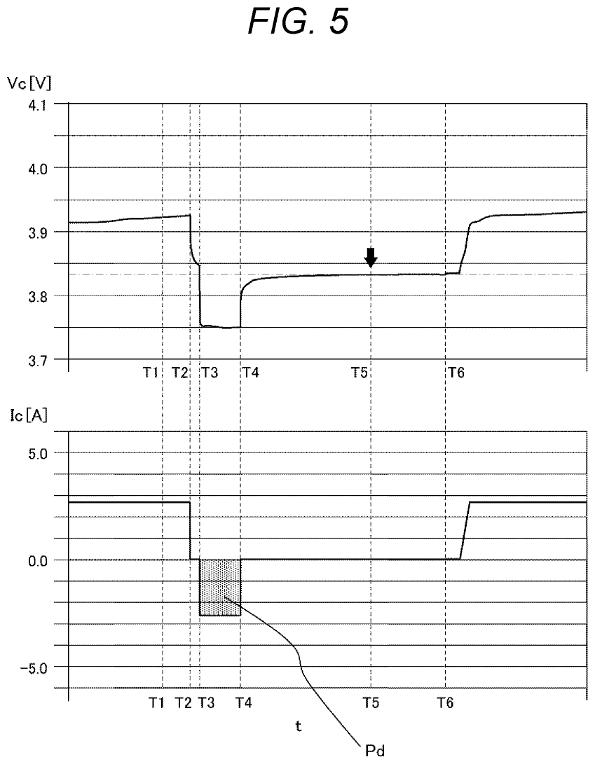

FIG. 5 is a waveform diagram for describing a process of discharging the battery in order to eliminate the polarization. The upper part of FIG. 5 is a time chart illustrating a voltage change of the battery cell 12, where the vertical axis represents the terminal voltage Vc [V] and the horizontal axis represents time t. The lower part of FIG. 5 is a time chart illustrating a current change of the battery cell 12, where the vertical axis represents a current Ic [A] and indicates that a current having a positive value in an upward direction in the figure flows so as to charge the battery cell 12, and the horizontal axis represents time t.

An example in which the integrated controller 27 plans to flow a reverse current to perform OCV measurement during charging at time T1 illustrated in FIG. 5 will be described. Then, an example in which charging, discharging for OCV measurement, and voltage measurement are terminated by time T6 will be described. Time T1 is set according to the purpose of OCV measurement in the form of a time point when a predetermined time elapses from the start of charging of the battery cell 12, a time point when the state of charge of the battery cell 12 reaches a predetermined value, or a time point before time T2 for making the state of charge reach a predetermined value at time T2 at which charging is stopped as described below.

At time T1, the charge/discharge amount determination unit 29 determines whether an operation for eliminating the polarization of the battery cell 12 performed between time T3 and time T4 is charging or discharging according to an amount of electricity related to charging performed up to a time before time T1, a charging state or temperature of the battery cell 12, and a state of a charging or discharging operation (a direction of the current Ic) currently being performed, and calculates the charge/discharge amount which is an amount of electricity to be charged or discharged for eliminating the polarization of the battery cell 12.

The amount of electricity for eliminating the polarization of the battery cell 12 is set such that the larger the absolute value of the current or the larger the amount of electricity, the larger the amount of electricity is set for charging or discharging performed up to a time before T1, and is set such that the amount of electricity increases as the temperature of the battery cell 12 (or the battery 11) decreases or the deterioration of the battery cell 12 progresses.

Such an amount of electricity is preferably set based on an experiment performed on the battery cell 12 or a simulation result obtained using the equivalent circuit model as illustrated in FIG. 1. For the obtained amount of electricity for eliminating the polarization of the battery cell 12, it is preferable that a lookup table, a response curved surface function, a neural network model, or the like is constructed such that a corresponding amount of electricity can be referred to based on whether the immediately preceding charging/discharging is charging or discharging, the amount of electricity in the immediately preceding charging/discharging, the temperature of the battery cell 12, and the deterioration state of the battery cell 12, and is held in the charge/discharge amount determination unit 29.

In the lookup table that refers to a plurality of conditions, combinations of computation amounts for referring to the table and the amounts of electricity recorded at grid points become enormous. Therefore, in particular, a factor that has a great influence on the amount of electricity necessary for eliminating polarization may be referred to from the lookup table, and other factors may be multiplied by individual correction amounts as coefficients.

The amount of electricity necessary for eliminating the polarization of the battery cell 12 has a large correlation between the amount of electricity required for the preceding charging or discharging and the state of charge of the battery cell 12. Therefore, a relationship between the amount of electricity of the immediately preceding charging or discharging, that is, a change amount of the state of charge and the state of charge may be set as the lookup table, and the amount of electricity necessary for eliminating the polarization may be calculated by multiplying a correction coefficient related to the temperature of the battery cell 12 and a correction coefficient related to the deterioration state of the battery cell 12.

In addition, a factor having a small influence may be omitted, or correction using a factor different from the above may be performed. In the charge/discharge amount determination unit 29, the charge/discharge amount of the battery cell 12 necessary for eliminating the polarization of the battery cell 12 may be obtained.

In a case where the charge/discharge amount of the battery cell 12 necessary for eliminating the polarization of the battery cell 12 is set based on the simulation result obtained using the equivalent circuit model, for example, the amount of electricity for eliminating the polarization may be estimated by applying to the equivalent circuit model as illustrated in FIG. 1 based on a voltage change from time T2 to time T3.

Through the above-described processes, the charge amount out of the charge/discharge amounts necessary for eliminating the polarization of the battery 11 corresponding to time T2 and an area from time T1 to time T2 in FIG. 5 is determined, and the amount of electricity for eliminating the polarization indicated by hatching from time T3 to time T4 in FIG. 5 is determined. An area of a shading portion in the figure indicates the amount of electricity for eliminating the polarization, and corresponds to a necessary discharge amount Pd out of the charge/discharge amounts necessary for eliminating the polarization of the battery 11.

An absolute value of the current value when discharging is performed from time T3 to time T4 is preferably equal to or more (in a negative direction in FIG. 5) than an absolute value of a current when charging is performed at time T1. As the discharging current is larger, discharging for eliminating the polarization is terminated in a shorter time, and a time required for performing OCV measurement can be shortened. However, in a case where a current for discharging a nominal capacity of the battery cell 12 in one hour, is 1 C (so-called 1 C rate), an extremely large current, for example, a current exceeding 3 C, is to be avoided. This is because new polarization occurs due to generation of a concentration gradient of the lithium ions in the electrolyte solution in the battery cell 12, and therefore, it is preferable to set the discharging current to a current value equal to or more (within a range not exceeding 3 C) than an absolute value of a current value at the time of preceding charging. Although the discharging current whose absolute value is smaller than the current value at the time of charging can also be used, the effect of shortening the time required to perform OCV measurement is reduced. It is sufficient if the amount of electricity for eliminating the polarization calculated by the charge/discharge amount determination unit 29 can be discharged in order to perform OCV measurement.

When discharging the power of the battery 11, the charge/discharge amount determination unit 29 may detect a discharge destination capable of receiving the power through the power information acquisition unit 30. The charge/discharge amount determination unit 29 may determine the charge/discharge amount in consideration of the information from the power information acquisition unit 30.

The power information acquisition unit 30 acquires the power consumable by the external equipment 111 of the home 100 by acquiring the power demand of the home 100 held by the HEMS 112 from the communication module 113 through the telematics unit 28. In a case where the battery 11 is being charged, the power demand measured by the power meter 108 also includes power necessary for charging the battery 11, and thus it is possible to estimate the power consumable by the external equipment 111 of the home 100 by subtracting the power necessary for charging the battery 11. Similarly, the power information acquisition unit 30 may acquire the upper limit power of the circuit breaker 107 of the home 100 held by the HEMS 112 to acquire the power that can be supplied by the home 100 as the external power supply. The power information acquisition unit 30 also acquires the power consumable by the internal equipment 18 of the vehicle 1. The power consumable by the internal equipment 18 may include a loss in the power conversion device 17. A specific power consumption method of the internal equipment 18 is described below.

Based on a result of detecting the discharge destination that can consume the power of the battery 11, the result being acquired through the power information acquisition unit 30, the discharge allocation determination unit 31 determines the discharge destination that consumes the power of the battery 11 from time T3 to time T4. There is no problem even if a plurality of discharge destinations are selected.

The discharge allocation determination unit 31 basically determines the discharge allocation so as to prioritize the power consumption of the external equipment 111 of the home 100 and to allocate the remaining power to the internal equipment 18. As described above, in order to efficiently eliminate the polarization, the magnitude of the current is also related, and thus it is desirable that the charge/discharge amount and the discharge allocation include information regarding the magnitude of the current and the timing. A method of determining the allocation is described below.

Based on the charge/discharge amount determined by the charge/discharge amount determination unit 29 and the discharge allocation determined by the discharge allocation determination unit 31, the charging/discharging control unit 32 controls execution of discharging of the battery 11 from time T3 to time T4. It is desirable to also use information regarding a current detection result of the current measurement unit 15 of the monitoring unit 13. In this manner, the discharging is performed until the amount of electricity for eliminating the polarization set by the charge/discharge amount determination unit 29 is consumed.

The integrated controller 27 prohibits charging and discharging of the battery 11 from time T4 to time T6, and at time T5 between time T4 and time T6, the voltage acquisition unit 33 measures the OCV of the battery cell 12 through the voltage measurement unit 14 of the monitoring unit 13. As for a time from time T4 to time T5, it is sufficient if a time considered to be sufficient for elimination of the polarization of the battery cell 12 elapses, and there is no problem as long as a predetermined value based on an experiment or a simulation result is set similarly to the amount of electricity for eliminating the polarization.

After time T6, the prohibition of charging and discharging of the battery 11 is released.

In the above description, a subsequent timing is determined based on time T1. However, for example, in a case where time T6 has already been determined as a scheduled charging completion time of the battery 11, time T6 may be determined first, and other timings may be set by tracing backward from time T6. In this case, since a forecast of a discharge period from time T3 to time T4 is not obtained, the time may be set based on the assumption that the internal equipment 18 of the vehicle 1 is the discharge destination, which does not depend on the power demand of the home 100.

Even if the amount of electricity for eliminating the polarization cannot be sufficiently discharged due to, for example, a large decrease in power consumable by the external equipment 111 during the execution of the method described in the present embodiment, the charges are consumed for eliminating the polarization as compared with a case where discharging is not performed, so that the effect of shortening an OCV measurement time as compared with a case where discharging is not performed can be obtained.

In addition, in the above description, an example in which charging is performed first has been described, but the present invention is not limited thereto, and discharging may be performed first. Since the basic idea is the same, a detailed description is omitted.

Next, a specific method by which the power information acquisition unit 30 acquires the power consumable by the internal equipment 18 of the vehicle 1 will be described.

For example, in a case where the internal equipment 18 is an air conditioner, the power of the battery 11 is converted by the bidirectional inverter that is the power conversion device 17, and the power is consumed by driving the air conditioner. Therefore, the power information acquisition unit 30 acquires, as the power consumable by the internal equipment 18, the total of power consumption of the air conditioner and a loss due to the bidirectional inverter that is the power conversion device 17.

In a case where the internal equipment 18 is the traveling motor, the charging/discharging control unit 32 controls the power conversion device 17 based on the discharge allocation, and supplies, to the traveling motor, power that generates a drive torque at which the traveling motor does not rotate. Specifically, in response to the command from the charging/discharging control unit 32, the controller (not illustrated) of the power conversion device 17 performs vector control of the bidirectional inverter with the drive torque at which the traveling motor does not rotate as an upper limit. More specifically, the controller (not illustrated) of the power conversion device 17 detects a mechanical angle of the traveling motor, and drives the bidirectional inverter so as to apply an alternating current to a phase in which a q-axis direction component for generating a torque in the traveling motor is 0 and a current flows only to a d-axis current component for generating a magnetic flux. Although it is preferable that the q-axis direction component is 0, it may be difficult to achieve such a value depending on the mechanical angle of the motor. In practice, on the premise that braking is reliably performed by a braking device such as a parking brake of the vehicle 1, the power information acquisition unit 30 estimates and acquires power consumed by energizing the traveling motor on the condition (upper limit) that the traveling motor does not rotate as the power consumable by the traveling motor, together with the loss in the bidirectional inverter. Therefore, when a braking force of the vehicle 1 is insufficient or the vehicle 1 is stopped on a slope, the power information acquisition unit 30 acquires a result indicating that there is no power consumable by the traveling motor.

In addition, in a case where the internal equipment 18 is an auxiliary battery (not illustrated) of the vehicle 1, the power information acquisition unit 30 selects a DC/DC converter for charging the auxiliary battery (not illustrated) as the power conversion device 17, selects the auxiliary battery (not illustrated) as the internal equipment 18, and calculates and acquires the power when the power of the battery 11 is consumed by driving the DC/DC converter and charging the auxiliary battery as the power consumable by the internal equipment 18 together with a loss in the DC/DC converter.

The internal equipment 18 is not limited thereto and is not particularly limited as long as the power of the battery 11 can be consumed.

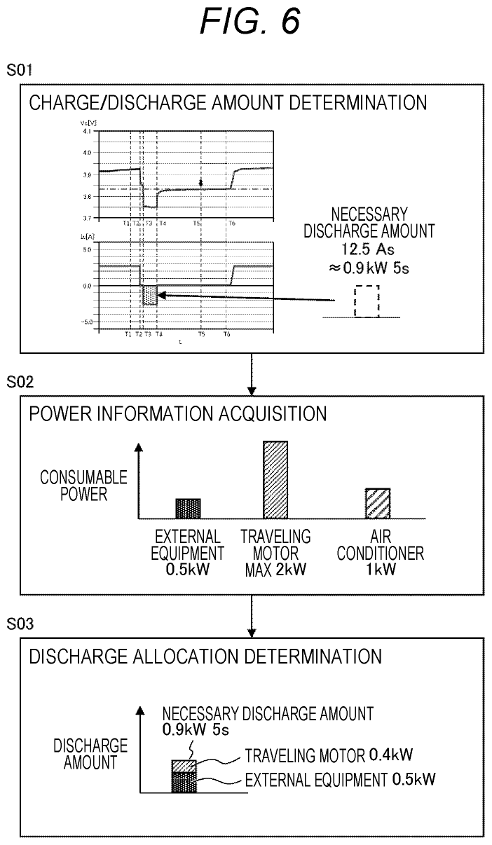

FIG. 6 is a diagram for describing a process in which the discharge allocation determination unit selects the discharge destination.

Step S01 is a charge/discharge amount determination step, in which the charge/discharge amount determination unit 29 determines the charge/discharge amount necessary for eliminating the polarization of the battery 11. Details are as described in FIG. 5, and thus a description thereof is omitted. Since the shading portion corresponds to the necessary discharge amount and is 12.5 As in FIG. 6, discharging of 0.9 kW for 5 s is required.

Step S02 is a power information acquisition step, in which the power information acquisition unit 30 acquires the power consumable by the external equipment 111 and the power consumable by the internal equipment 18. In this example, the vertical axis of the graph represents the consumable power, and the horizontal axis represents breakdown of the external equipment or the internal equipment. Information indicating that the power consumable by the external equipment 111 is 0.5 kw, and the power consumable by the internal equipment 18 is a maximum of 2 for the energization of the traveling motor and 1 kW for the air conditioner can be acquired.

Step S03 is a discharge allocation determination step, in which the discharge allocation determination unit 31 determines the discharge allocation based on the charge/discharge amount determined in step S01 and the information from the power information acquisition unit 30 acquired in step S02. Here, the discharge allocation determination unit 31 selects the discharge destination by evaluating whether or not the power of the battery 11 can be effectively utilized, whether or not the power control is easy, and the like.

For example, in a case where the external equipment 111 in the home 100 consumes the power by performing discharging to the home 100, an effect of reducing the electricity costs for the home 100 can be expected. Therefore, the remaining power of 0.4 kW is consumed by energization of the traveling motor while meeting the power demand of 0.5 kW of the home 100. By determining the allocation in this manner, it is possible to secure the discharge amount necessary for eliminating the polarization of the battery 11. Since the power is consumed as heat in the energization of the traveling motor, the allocation to the external equipment 111 is prioritized in order to effectively use the power of the battery 11.

In addition, by allowing discharging to the external equipment 111 and discharging to the internal equipment 18 to occur simultaneously, it is possible to easily secure a necessary discharge amount.

### Second Embodiment

A second embodiment is a modified example of the first embodiment and is an embodiment in which, when a remaining time until a scheduled departure time of a vehicle 1 is equal to or shorter than a predetermined value and an outside air temperature is equal to or lower than a predetermined value, a discharge allocation determination unit 31 determines a discharge allocation with priority given to an allocation destination for promoting warm-up of the vehicle 1.

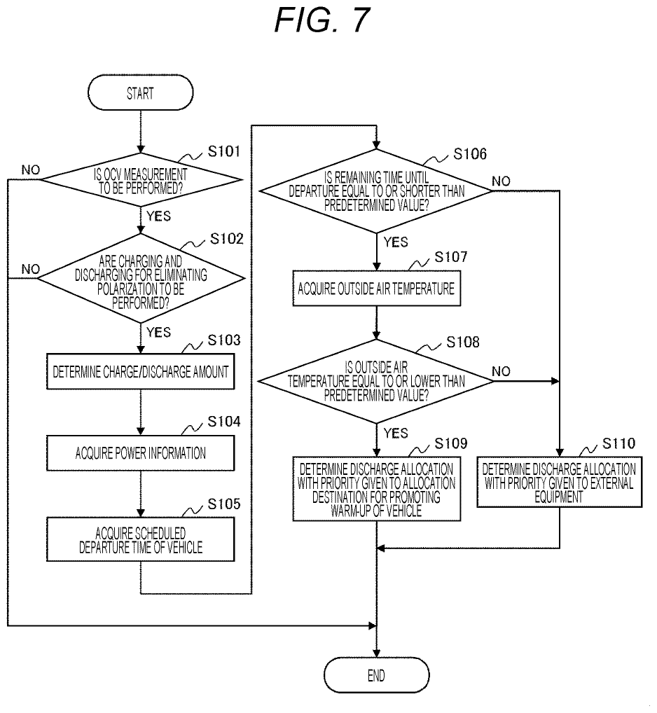

FIG. 7 is a flowchart for describing an operation of the second embodiment.

Steps S101 to S104 are operations similar to those in the first embodiment.

In step S101, an integrated controller 27 determines Whether or not to perform OCV measurement. In a case where the OCV measurement is not to be performed (NO), the processing ends. In a case where the OCV measurement is to be performed (YES), the processing proceeds to step S102.

In step S102, the integrated controller 27 determines whether or not to perform charging and discharging for eliminating polarization of a battery 11. For example, in a case where the charging and discharging are not performed by performing the OCV measurement by another method or the like (NO), the processing ends. In a case where the charging and discharging are performed (YES), the processing proceeds to step S103.

Step S103 corresponds to step S01 in FIG. 6, and step S104 corresponds to step S02 in FIG. 6.

Steps S105 to S110 are steps performed instead of step S03 in FIG. 6.

In step S105, the discharge allocation determination unit 31 of the integrated controller 27 acquires the scheduled departure time of the vehicle 1 through a telematics unit 28 or the like. For example, the scheduled departure time is calculated based on information such as a time set in advance as a target time for completion of charging and reservation of an air conditioner before boarding.

In step S106, the discharge allocation determination unit 31 determines whether or not the remaining time until the departure is equal to or shorter than a predetermined value. In a case where the remaining time is equal to or shorter than the predetermined value (YES), the processing proceeds to step S107. In a case where the remaining time is longer than the predetermined value (NO), the processing proceeds to step S110.

In step S107, the discharge allocation determination unit 31 acquires the outside air temperature through, for example, an outside air temperature sensor (not illustrated). The acquisition of the outside air temperature may be estimated, for example, by acquiring a cooling water temperature through a cooling water temperature sensor (not illustrated).

In step S108, the discharge allocation determination unit 31 determines whether or not the outside air temperature is a temperature at which promoting warm-up of the vehicle 1 is desirable, such as a temperature that is equal to or lower than a predetermined value (for example, below zero or equal to or lower than 5 degrees). In a case where the outside air temperature is equal to or lower than the predetermined value (YES), the processing proceeds to step S109. In a case where the remaining time is longer than the predetermined value (NO), the processing proceeds to step S110.

In step S109, since promoting warm-up of the vehicle 1 is desirable, the discharge allocation determination unit 31 determines the discharge allocation with priority given to the allocation destination for promoting warm-up of the vehicle 1, such as the air conditioner serving as internal equipment 18 of the vehicle 1 as a discharge destination of the power of the battery 11. Since the warm-up of the vehicle 1 needs to use the power of the battery 11, when the warm-up is necessary, the power of the battery 11 can be more effectively used in the case of allocating the power to the air conditioner or the like of the vehicle 1 than in the case of allocating the power to external equipment as in the second embodiment.

In step S110, since the warm-up of the vehicle 1 is unnecessary, the discharge allocation determination unit 31 determines the discharge allocation with priority given to external equipment 111 as in the first embodiment.

Although an example in which the determination is made based on the outside air temperature has been described here, the determination is not limited thereto, and the determination may be made using another temperature such as the cooling water temperature.

### Third Embodiment

A third embodiment is a modified example of the first embodiment and is an embodiment in which a power information acquisition unit 30 acquires a time series of power consumable by external equipment 111, and a discharge allocation determination unit 31 prioritizes an allocation to internal equipment 18 in a case where a minimum value of the time series of power consumable by external equipment 111 is equal to or less than a predetermined value.

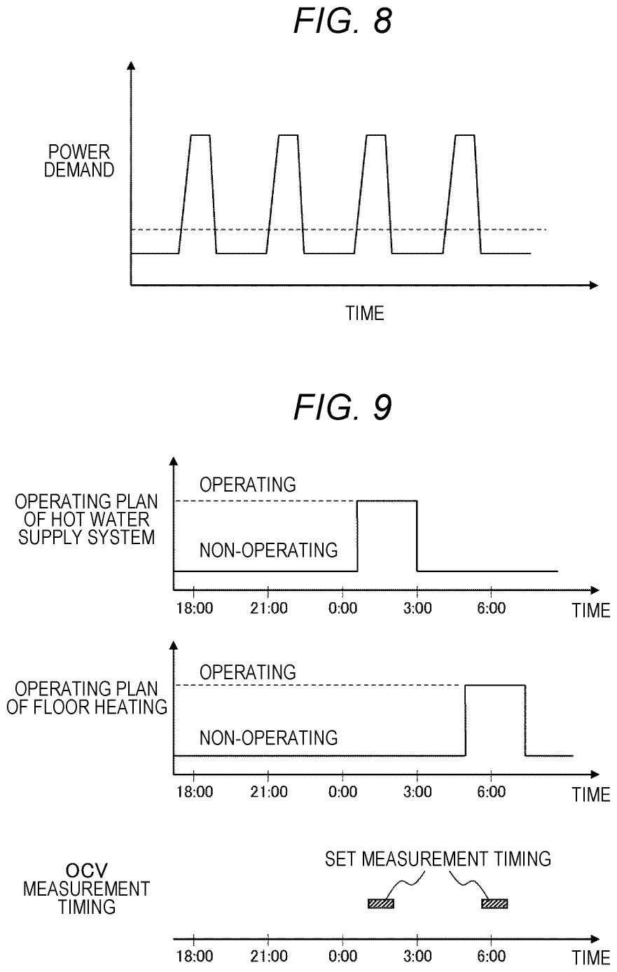

FIG. 8 is a time-series waveform diagram of a power demand of a home for describing an operation of the third embodiment. In FIG. 8, the vertical axis represents a power demand of the external equipment 111 of a home 100, and the horizontal axis represents time.

In the present embodiment, the power information acquisition unit 30 periodically refers to the power demand while a vehicle 1 is connected to the home 100, and holds the power demand in time series.

As illustrated in FIG. 8, in a case where an increase and decrease in power demand of the home 100 are large and are repeated, for example, in a case where only one washing machine or air conditioner of the home 100 is operated, if the external equipment 111 is selected as a discharge destination, there is a problem that an expected power demand cannot be obtained, and a discharge amount cannot be secured or it may take time to secure the discharge amount and it may thus take time to perform OCV measurement.

Therefore, in the present embodiment, when the minimum value of the time series of the power consumable by the external equipment 111 is equal to or less than a predetermined value indicated by a dotted line in FIG. 8, the discharge allocation determination unit 31 prioritizes an allocation to the internal equipment 18. This makes it possible to avoid the problem as described above.

### Fourth Embodiment

A fourth embodiment is a modified example of the first embodiment and is an embodiment in which a power information acquisition unit 30 acquires an operating plan of external equipment 111, and a charge/discharge amount determination unit 29 detects a time zone in which power consumable by the external equipment 111 is large based on the operating plan, and sets the time zone as a timing for the next open circuit voltage measurement.

FIG. 9 is a timing chart for describing an operation of the fourth embodiment.

The power information acquisition unit 30 of the present embodiment acquires the operating plan of the external equipment 111 through an HEMS 112.

The upper part of FIG. 9 illustrates an operating plan of a hot water supply system, and the middle part illustrates an operating plan of floor heating. The horizontal axis represents time, and the vertical axis represents an operating or non-operating state. As described above, if the operating plan of the external equipment 111 can be acquired in advance, power of a battery 11 can be supplied to a home 100 in the time zone in which a power demand of the home 100 is high, and the power of the battery 11 can be used without waste.

Therefore, as illustrated in the lower part of FIG. 9, the charge/discharge amount determination unit 29 sets an OCV measurement timing so as to match operating periods of the external equipment 111. For example, the charge/discharge amount determination unit 29 sets time T5 that is the OCV measurement timing in FIG. 5 and a period (from time T3 to time T4) during which discharging for eliminating polarization is performed.

### Fifth Embodiment

A fifth embodiment is a modified example of the first embodiment and is an embodiment in which a power information acquisition unit 30 acquires a charging/discharging timing of another vehicle 1, and a discharge allocation determination unit 31 determines a discharge allocation such that discharging is performed at a timing at which another vehicle 1 is charged.

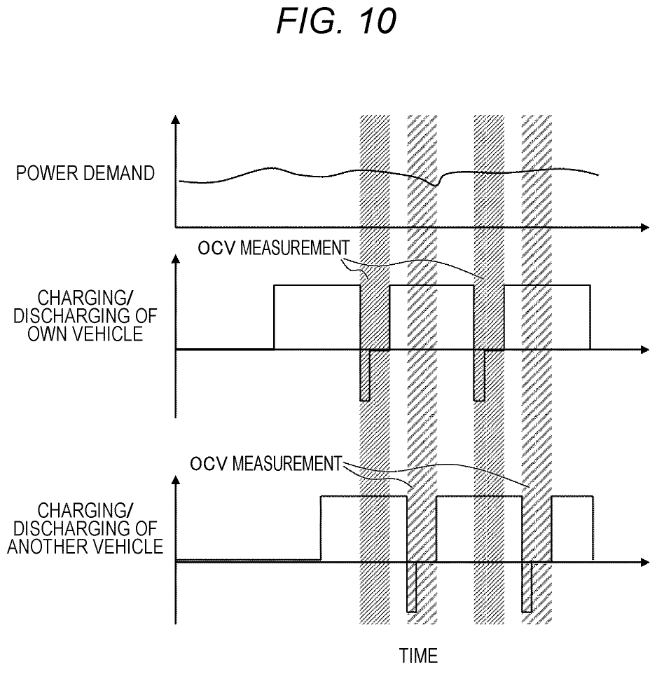

FIG. 10 is a waveform diagram for describing an operation of the fifth embodiment.

In the present embodiment, in a case where a plurality of vehicles 1 are connected to the home 100, an OCV measurement timing is set such that charging and discharging necessary for eliminating polarization are not simultaneously performed in order not to exceed a power demand of a home 100.

The power information acquisition unit 30 acquires a measurement result of a power meter 108 as the power demand of the home 100 through an HEMS 112, communicates with another vehicle 1 connected to the home 100 through a telematics unit 28, and adjusts a charging/discharging execution time such that discharging performed to eliminate polarization of a battery 11 does not exceed the power demand of the home 100.

In addition, such adjustment includes adjusting a charging time of another vehicle 1 and a discharging time in OVC measurement of the own vehicle such that the vehicle 1, that is the own vehicle, performs discharging when another vehicle 1 performs charging, and the power demand of the home 100 from the perspective of the vehicle 1 increases.

The upper part of FIG. 10 illustrates the power demand of the home 100, the middle part illustrates a power forecast of charging and discharging of the vehicle 1 that is the own vehicle, and the lower part illustrates a power forecast of charging and discharging of another vehicle 1. The vertical axis represents power, and the horizontal axis represents time. In addition, upward directions along the vertical axes of the middle and lower parts represent charging and downward directions along the vertical axes of the middle and lower parts represent discharging.

When the plurality of vehicles 1 simultaneously perform discharging in order to eliminate the polarization of the respective batteries 11, there is a possibility that the discharged power exceeds the power demand of the home 100.

In order to avoid such a problem, by adjusting charging/discharging times such that a discharging time at which the vehicle 1 that is the own vehicle indicated by fine shading eliminates the polarization to perform OCV measurement and a discharging time at which another vehicle 1 indicated by coarse shading eliminates the polarization to perform OCV measurement do not overlap with each other, it is possible to perform charging/discharging for eliminating the polarization without exceeding the power demand of the home 100 and eventually without shortage of the discharge amount necessary for eliminating the polarization.

### Sixth Embodiment

A sixth embodiment is a modified example of the first embodiment and is an embodiment in which a discharge amount for eliminating polarization can be secured even in a case where information regarding a power demand of a home 100 is not obtained by a power information acquisition unit 30. Therefore, a discharge allocation determination unit 31 prioritizes an allocation to external equipment 111 and allocates remaining power to internal equipment 18.

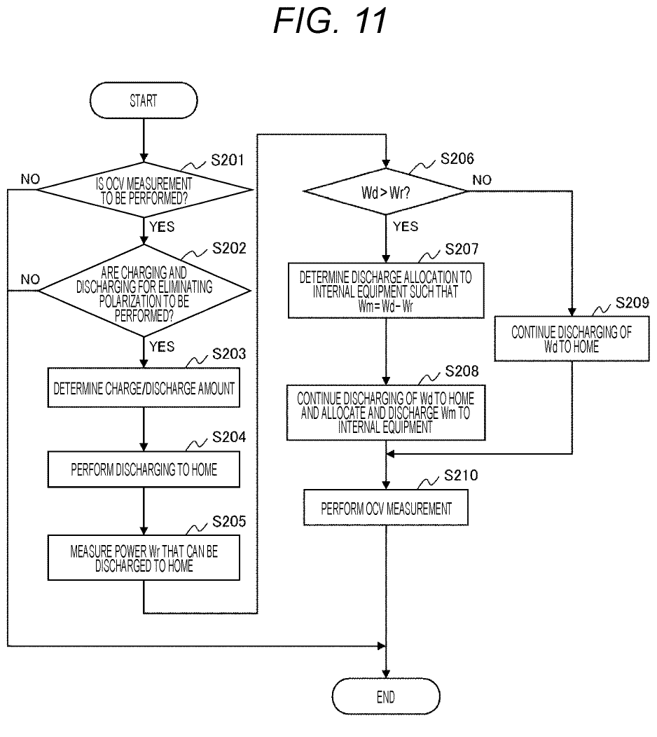

FIG. 11 is a flowchart for describing an operation of the sixth embodiment.

In the present embodiment, it is assumed that the power demand of the home 100 cannot be acquired through a telematics unit 28. For example, such a case corresponds to a case where an HEMS 112 is not installed in the home 100 and AC charging is performed through an AC charging port 24, a charging cable 25, and an AC outlet 105. In addition, it is also possible to implement the present embodiment when the power information acquisition unit 30 cannot acquire the power demand of the home 100.

Since steps S201 to S203 are the same operations as steps S101 to S103 in FIG. 7 of the first embodiment and the second embodiment, a description thereof will be omitted.

Steps S204 to S207 are steps performed instead of step S03 in FIG. 6.

In step S204, in order to satisfy the discharge amount determined in step S203, the discharge allocation determination unit 31 determines the discharge allocation so as to satisfy an unknown power demand of the home 100, and a charging/discharging control unit 32 starts discharging.

In step S205, the power information acquisition unit 30 or the discharge allocation determination unit 31 measures and acquires power discharged from a bidirectional charger 20 to the home 100 as power Wr that can be discharged to the home 100.

In step S206, the discharge allocation determination unit 31 compares a target value Wd of the discharge amount necessary for eliminating the polarization determined by a charge/discharge amount determination unit 29 with the power Wr that can be discharged to the home 100 acquired in step S205. Here, in a case where Wd>Wr, that is, in a case where the power demand of the home 100 is insufficient for the discharge amount necessary for eliminating the polarization (YES), the processing proceeds to step S207. In a case where Wd>Wr is not satisfied (NO), the processing proceeds to step S209.

In step S207, the discharge allocation determination unit 31 allocates remaining power to the internal equipment 18 of a vehicle 1 such that a time required for OCV measurement can be shortened. That is, in step S207, the discharge allocation to the internal equipment 18 is determined such that a discharge amount Wm to the internal equipment 18=Wd−Wr.

In step S208, the charging/discharging control unit 32 allocates and discharges Wm determined in step S207 to the internal equipment 18 while continuing discharging of Wd to the home 100.

In step S209, since the power demand of the home 100 is sufficient to eliminate the polarization of a battery cell 12, the charging/discharging control unit 32 continues discharging to the home 100.

In step 210, a voltage acquisition unit 33 performs OCV measurement triggered by discharging of a predetermined amount of electricity.

As a result, even when the power demand of the home 100 is not obtained by the power information acquisition unit 30, it is possible to shorten a time necessary for OCV measurement while effectively utilizing the power of the battery 11 by determining the discharge allocation so as to discharge the power of the battery 11 to the home 100 and discharge the remaining power to the internal equipment 18.

Furthermore, in the present embodiment, a case where the power demand of the home 100 cannot be obtained by the power information acquisition unit 30 through the telematics unit 28 has been described, but the present invention is not limited thereto, and the present invention can also be applied to a case where the power demand of the home 100 acquired by the power information acquisition unit 30 fluctuates between time T3 and time T4, which are discharging timings, and the power demand decreases. That is, the discharge allocation determination unit 31 may adjust the power consumed by the internal equipment 18 while feeding back the power sent to the home 100 by the bidirectional charger 20 (or stationary charger 101) so as to satisfy the target value Wd of the discharge amount necessary for eliminating the polarization.

### Seventh Embodiment

A seventh embodiment is a modified example of the first embodiment and is an embodiment in which apparent OCV measurement is performed in a case where a power demand of a home 100 is high by using a method different from that of the first embodiment.

In the present embodiment, if resistance components R0 and R1 of an equivalent circuit model of a battery cell illustrated in FIG. 1 have the same value for charging and discharging, charging and discharging are performed such that absolute values of currents are substantially the same, whereby the same DC voltage is generated for the resistance components R0 and R1. Therefore, it is assumed that an average value of a terminal voltage Vc+ at the time of charging and a terminal voltage Vc− at the time of discharging corresponds to an OCV. The term “substantially the same” as used herein means being the same within an allowable error range, and it is sufficient that the values fall within the allowable error range in view of accuracy that can be controlled by current and voltage sensors, charging means, and discharging means that can be used in actual operation.

Specifically, in the present embodiment, a power information acquisition unit 30 acquires power that can be supplied by an external power supply and a power demand of external equipment 111, a charge/discharge amount determination unit 29 determines a charge/discharge amount for performing low-rate charging/discharging in a case where the power demand acquired by the power information acquisition unit 30 is higher than a predetermined value, and a voltage acquisition unit 33 acquires a result of measuring a voltage of a battery 11 at each of timings during low-rate charging/discharging and low-rate discharging, and estimates the open circuit voltage OCV based on an average value of the measurement results.

Here, the charge/discharge amount includes information regarding a magnitude of a current and a timing, and the charge/discharge amount determination unit 29 desirably determines the charge/discharge amount such that a difference between an absolute value of a magnitude of a charging current and an absolute value of a magnitude of a discharging current is within 5%.

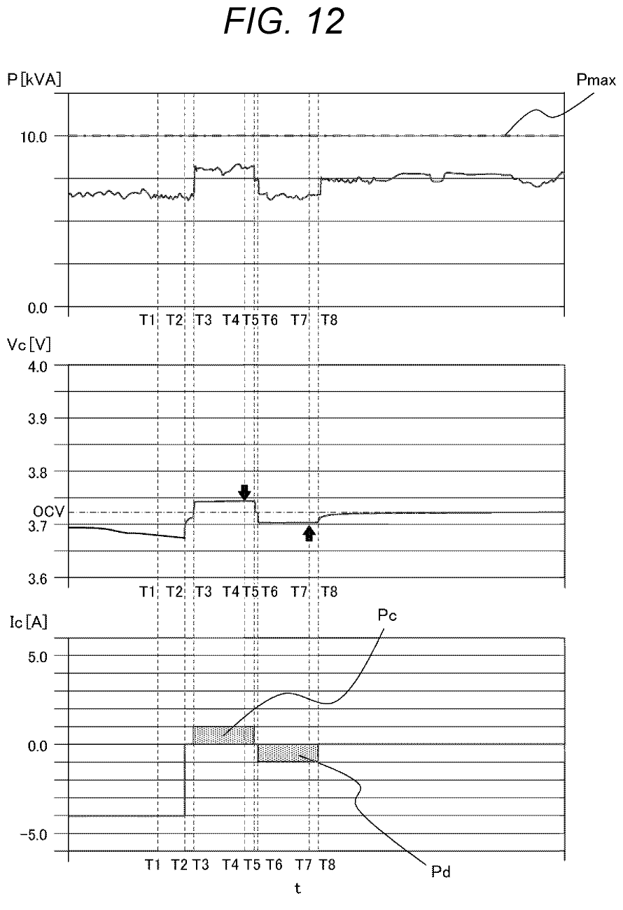

FIG. 12 is a waveform diagram for describing a process of measuring an apparent OCV for describing an operation of the seventh embodiment.

The upper part of FIG. 12 illustrates a power demand P of the home 100, the vertical axis represents the power demand P [kVA], and the horizontal axis represents time t. Contract power Pmax of the home 100 indicated by a one-dot chain line in the figure is 10 kVA, indicating that the power demand P of the home 100 is high and there is no margin below the contract power Pmax.

The middle part of FIG. 12 illustrates a voltage change of a battery cell 12 in the battery 11 of a vehicle 1, where the vertical axis represents the terminal voltage Vc [V] and the horizontal axis represents time. At time T1, discharging to the home 100 is performed, and a part of the power demand P of the home 100 is borne by the power of the battery 11.

The lower part of FIG. 12 illustrates a charging/discharging current of the battery cell 12, where the vertical axis represents a current Ic [A] and indicates that a positive current in an upward direction flows so as to charge the battery cell 12. The horizontal axis represents time. In such a case, it is also possible to postpone OCV measurement of the battery cell 12, but in the present embodiment, the apparent OCV is measured.

If the charging current is attempted to flow to the battery cell 12 such that the absolute value of the charging current is equal to or larger than that of the current discharged by the battery cell 12 at time T1 in order to eliminate polarization according to the method of the first embodiment, a stationary charger 101 and a bidirectional charger 20 request power from the home 100. However, the power demand P of the home 100 is in a high state at time T1, and there is a high possibility that a circuit breaker 107 of the home 100 operates and a breaker of the home 100 is shut off when charging is started.

Therefore, in the present embodiment, when the power demand P of the home 100 is higher than a predetermined value, the battery cell 12 is charged and discharged at a low rate, a voltage of the battery cell 12 is measured by a voltage measurement unit 14 during charging and discharging, and an average is taken to measure the apparent OCV.

Whether or not the power demand P of the home 100 is higher than a predetermined value can be determined, for example, by comparing the power demand P of the home 100 with a threshold. The threshold can be calculated, for example, by multiplying upper limit power of the circuit breaker 107, which is power that can be supplied by the external power supply, acquired by the power information acquisition unit 30, that is, the contract power Pmax, by a predetermined coefficient smaller than 1. The present invention is not limited thereto, and the threshold may be determined in advance.

When measuring the apparent OCV, it is desirable that the absolute values of the charging current and the discharging current are substantially the same as each other, for example, a difference therebetween is within 5%, and a charging time from time T3 to time T5 and a discharging time from time T6 to time T8 are also substantially the same as each other, for example, a difference therebetween is within 5%. In this case, a charge amount Pc and a discharge amount Pd, which are areas indicated by hatching in the lower part of FIG. 12, are substantially the same as each other. Since the absolute value of the current has a greater influence than the time, the charging time and the discharging time do not have to be substantially the same as each other.

Here, the low-rate charging is desirably 0.2 C or lower, for example, 0.2 C or 0.01 C, and is set within a range in which the home 100 does not undergo a power failure even if the battery cell 12 is charged. For this purpose, it is desirable to determine a low-rate charge amount within a range in which the home 100 does not undergo a power failure, and determine a low-rate discharge amount based on the low-rate charge amount. In addition, in a case where the rate is excessively low, the rate cannot be measured by a sensor, and thus the rate is desirably 0.01 C or higher.

Based on the equivalent circuit model of the battery cell 12 illustrated in FIG. 1, if the same resistance value of the DC components R0 and R1 is assumed for each of charging and discharging, the average value of the terminal voltage Vc+ at the time of charging acquired at time T4 and the terminal voltage Vc− at the time of discharging acquired at time T7 is the apparent OCV.

Since the obtained apparent OCV is strictly different from the original OCV, the apparent OCV can be used for determination of a state of charge and deterioration estimation as an OCV after appropriate correction reflecting experimental results and simulation results is performed.

In this way, even if there is a possibility that the power demand P of the home 100 increases and exceeds the contract power Pmax of the home 100 in a case where charging for eliminating the polarization of the battery cell 12 is performed, the apparent OCV can be measured.

Although the embodiments of the present invention have been described above, the present invention is not limited to the configurations described in the embodiments, and various modifications can be made within the scope of the technical idea of the present invention. In addition, some or all of the configurations described in the respective embodiments may be applied in combination.

### REFERENCE SIGNS LIST

1 vehicle
11 battery
12 battery cell
13 monitoring unit
14 voltage measurement unit
15 current measurement unit
16 temperature measurement unit
17 power conversion device
18 internal equipment
19 charging circuit
20 bidirectional charger
21 DC/DC converter unit
22 inverter unit
23 control unit
24 AC charging port
25 charging cable
26 DC charging port
27 integrated controller
28 telematics unit
29 charge/discharge amount determination unit
30 power information acquisition unit
31 discharge allocation determination unit
32 charging/discharging control unit
33 voltage acquisition unit
100 home
101 stationary charger
102 DC/DC converter unit
103 inverter unit
104 control unit
105 AC outlet
106 distribution board
107 circuit breaker
108 power meter
109 power grid
110 solar power generation system
111 external equipment
112 HEMS
113 communication module
Vo voltage source
Vc terminal voltage
R0, R1 resistance component
C1 capacitance component
OCV open circuit voltage
Vdc DC voltage
Vp polarization voltage
Tc charging period
Ts rest period
t time
Rsht shunt resistor
Ic current
Pd discharge amount
Wr power that can be discharged to home
Wd target value of discharge amount necessary for eliminating polarization
Wm discharge amount to internal equipment
P power demand of home
Pmax contract power of home
Pc charge amount

1. A charging system that charges a battery mounted on a vehicle with power supplied from an external power supply, the charging system comprising:
a charging/discharging control unit that controls execution of charging and discharging of the battery;
a voltage acquisition unit that acquires a result of measuring a voltage of the battery at a predetermined timing from a voltage measurement unit that measures the voltage of the battery;
a charge/discharge amount determination unit that determines a charge/discharge amount of the battery necessary for measurement of an open circuit voltage of the battery; and
a discharge allocation determination unit that determines a discharge allocation which is an allocation of an internal discharge amount consumed by internal equipment of the vehicle and an external discharge amount consumed by external equipment of the vehicle, the internal discharge amount and the external discharge amount being necessary for discharging of the charge/discharge amount in the battery,
wherein the discharge allocation determination unit allows an allocation in which the internal discharge amount and the external discharge amount are simultaneously larger than 0.

2. The charging system according to claim 1, wherein
the charge/discharge amount determination unit determines the charge/discharge amount necessary for eliminating polarization of the battery, and
the voltage acquisition unit acquires a result of measuring the voltage of the battery at a timing after both charging and discharging of the charge/discharge amount is performed in the battery.

3. The charging system according to claim 2, wherein
the charge/discharge amount includes information regarding a magnitude of a current and a timing, and
the charge/discharge amount determination unit determines the charge/discharge amount such that the magnitude of the current in one of charging and discharging that is performed later is equal to or larger than the magnitude of the current in the other of charging and discharging that is performed earlier.

4. The charging system according to claim 2, comprising a power information acquisition unit that acquires power consumable by the external equipment and power consumable by the internal equipment,
wherein the discharge allocation determination unit determines the discharge allocation based on the charge/discharge amount and information from the power information acquisition unit.

5. The charging system according to claim 4, wherein
the discharge allocation determination unit prioritizes an allocation to the external equipment and allocates remaining power to the internal equipment.

6. The charging system according to claim 4, wherein
when a remaining time until a scheduled departure time of the vehicle is equal to or shorter than a predetermined value and an outside air temperature is equal to or lower than a predetermined value, the discharge allocation determination unit determines the discharge allocation with priority given to an allocation destination for promoting warm-up of the vehicle.

7. The charging system according to claim 4, wherein
the power information acquisition unit acquires a time series of the power consumable by the external equipment, and
the discharge allocation determination unit prioritizes an allocation to the internal equipment in a case where a minimum value of a time series of the power consumable by the external equipment is equal to or less than a predetermined value.

8. The charging system according to claim 4, wherein
the power information acquisition unit acquires an operating plan of the external equipment, and
the charge/discharge amount determination unit detects a time zone in which the power consumable by the external equipment is large based on the operating plan, and sets the time zone as a timing for next open circuit voltage measurement.

9. The charging system according to claim 4, wherein
the power information acquisition unit acquires a charging/discharging timing of another vehicle, and
the discharge allocation determination unit determines the discharge allocation such that discharging is performed at a timing at which the another vehicle is charged.

10. The charging system according to claim 2, wherein
the discharge allocation determination unit prioritizes an allocation to the external equipment and allocates remaining power to the internal equipment.

11. The charging system according to claim 1, comprising
a power information acquisition unit that acquires power suppliable by the external power supply and a power demand of the external equipment,
wherein the charge/discharge amount determination unit determines the charge/discharge amount for performing low-rate charging/discharging in a case where the power demand acquired by the power information acquisition unit is higher than a predetermined value, and
the voltage acquisition unit acquires the result of measuring the voltage of the battery at each of timings during low-rate charging/discharging and low-rate discharging, and estimates the open circuit voltage based on an average value of the measurement results.

12. The charging system according to claim 11, wherein
the charge/discharge amount includes information regarding a magnitude of a current and a timing, and
the charge/discharge amount determination unit determines the charge/discharge amount such that a difference between an absolute value of a magnitude of a charging current and an absolute value of a magnitude of a discharging current is within 5%.

13. The charging system according to claim 1, comprising:
the battery;
the voltage measurement unit;
a bidirectional charger that bidirectionally converts the power supplied from the external power supply and power discharged from the battery;
the internal equipment; and
a power conversion device that performs power conversion on the power discharged from the battery and supplies the power to the internal equipment.

14. The charging system according to claim 13, wherein
the internal equipment includes a traveling motor used for traveling of the vehicle, and
the charging/discharging control unit controls the power conversion device based on the discharge allocation, and supplies power for generating a drive torque at which the traveling motor does not rotate to the traveling motor.

15. The charging system according to claim 13, wherein
the internal equipment includes an air conditioner.
